(19) United States
(12) Patent Application Publication
(10) Pub. No.: US 2018/0302572 A1
(43) Pub. Date: Oct. 18, 2018

(54) THREE-DIMENSIONAL IMAGE CAPTURING SYSTEM AND METHOD FOR OBTAINING THREE-DIMENSIONAL IMAGES

(71) Applicant: Jacob Barnes, Madison, WI (US)

(72) Inventor: Jacob Barnes, Madison, WI (US)

(21) Appl. No.: 15/955,423

(22) Filed: Apr. 17, 2018

Related U.S. Application Data
(60) Provisional application No. 62/486,225, filed on Apr. 17, 2017.

(51) Int. Cl. H04N 5/247; G03B 17/56; E04C 3/04; H04N 13/243; H04N 5/225; H04R 3/00; G06T 15/20; G06T 17/05; G02B 5/32; G02B 27/22

(52) U.S. Cl. CPC H04N 5/247; G03B 17/561; E04C 3/04; H04N 13/243; H04N 5/2253; E04C 2003/0486; H04R 3/005; G06T 15/205; G06T 17/05; G02B 5/32; G02B 27/2292; H04N 5/2256

(57) ABSTRACT

A system for capturing three-dimensional images, the system comprising: a truss assembly having a truss frame defining an interior, the truss assembly coupled to an array of cameras, lights, and microphones directed towards the interior, wherein the truss assembly may be of a polyhedron shape and wherein a subject may be located within the interior; the array of cameras being distributed throughout the truss assembly. Also disclosed is a system for capturing three-dimensional images wherein the cameras, lights, and microphones capture the subject from enough angles to generate a three-dimensional virtual model of the subject.

### CROSS-REFERENCE TO RELATED APPLICATIONS

This application claims priority to U.S. Provisional Patent Application Ser. No. 62/486,225, filed Apr. 17, 2017, which is incorporated in its entirety herein by reference.

### FIELD

The present inventions relate to the field of image capturing. The present inventions more specifically relate to capturing of audio and video for reproduction of a three-dimensional moving image.

### BACKGROUND

Holograms have become ubiquitous in popular culture. In particular, science fiction films frequently feature holograms as a futuristic form of communication. For example, one of the most popular movie series of all time, Star Wars, has used holograms across many of the films within the franchise. Princess Leia's famous message, “Help me Obi Wan Kenobi” which set off the course of the films, was transmitted via hologram. Many other films both within and beyond the Star Wars franchise have held out holograms as the communication mechanism of the future. Music festivals have started bringing holograms to live audiences.

With the popularization of virtual reality, holograms have begun to make their way from the big screen to consumers. Virtual, augmented, and mixed reality headsets like the HoloLens, Galaxy Gear, Oculus Rift, have become increasingly common. These headsets may allow for users to interact with three-dimensional renderings of individuals and objects. In fact, the makers of the HoloLens advertise meetings conducted wearing the headset with individuals via a hologram as if the meeting was conducted in person.

Despite the increasing ubiquity of holograms, the mechanisms to capture these three-dimensional images typically require the subject to be substantially static. In other words, the hologram, for example, of an individual, may not be able to move in space. The subject then may appear to be standing still or have a limited range of movement.

Known mechanisms used to record holograms are not capable of handling a subject (i.e., a live subject such as a human) that moves beyond a substantially confined area. For example, a three-dimensional image capturing system for use with a Microsoft HoloLens may require a subject to stay in a limited space with a limited spatial range. Similarly, in another example, the Matrix Ring 360 by Fractal System presents a number of cameras installed on a steel truss. Individuals then step in the middle of the series of cameras. Again, the capture is limited to a confined, defined area.

Technology typically used by laypersons to capture objects for three-dimensional (“3d”) rendering such as 3d printing has similar issues. Image capture for this use case typically involves taking a number of pictures of an object staying perfectly still at a constant distance.

In other words, known three-dimensional image capturing systems (whether for a stationary rendering or hologram) have disadvantages. The ability to create a three-dimensional image of an individual, for example as a hologram, is confined to a particular rigid, bounded space. This approach makes capturing an individual in motion beyond the limited means provided in the bounded space—for example, playing sports, impossible. For example, the capture of a gymnast's floor exercise, which takes place in a 39 foot by 39 foot mat, could not be recorded using known technology.

Accordingly, there is a need for a three-dimensional image capturing system that provides for subject mobility.

### SUMMARY

It would be desirable to provide a three-dimensional image capturing system that would allow for subject mobility. It would be desirable to have an image capturing system that can follow subjects in space. It would be desirable to have a system that can be assembled and disassembled for movement into differing spaces. It would be desirable to have a system capable of facilitating “holoportation” or three-dimensional remote interaction (through a virtual reality headset, for example) of moving subjects. It would be desirable to provide for a system and device with improved rendering for three-dimensional models.

It would be desirable to provide for a system and device for higher quality but less expensive special effects. It would be desirable to provide for a system and method that can produce highly interactive environments for applications like crime scene investigations and criminal law applications. It would be desirable to provide for a system that can capture three-dimensional renderings of a microscopic object. It would be desirable to provide for a system that can capture three-dimensional footage using a highly mobile drone-based system. It would be desirable to provide for a system that can allow for three-dimensional image capturing using an individual's hands as well as capturing one or more hands performing certain movements.

Accordingly, a system and method for capturing three-dimensional images is disclosed. The system in various embodiments may allow for the capturing of images (e.g., video) of moving objects. The system may also allow for the simultaneous capture of audio. The system in various embodiments may consist of an array of cameras, lights, microphones, and tracking devices situated in a truss (for example, a spherical polyhedron truss). The system which may include a truss assembly may be arranged in such a way that the image subject (or subjects) is/are captured from enough angles to generate a three-dimensional virtual model of every frame. This functionality may be enabled in various embodiments by one or more cameras facing inward (i.e., towards an interior of a truss assembly, in various embodiments), creating inverse panoramas.

In various embodiments, the system and method may comprise one or more scoop doors. In various embodiments, the system and method may comprise a moving surface such as a treadmill or walkway for one or more subjects. In various embodiments, the system and method may comprise a number of microscopes. In various embodiments, the system and method may comprise a hands-on capturing (e.g., image capturing) variant. In various embodiments, the system may comprise a number of drones arranged to capture three-dimensional images of moving subjects.

A system for capturing three-dimensional images, the system comprising: a truss assembly having a truss frame defining an interior, the truss assembly coupled to an array of cameras, lights, and microphones directed towards the interior, wherein the truss assembly may be of a polyhedron shape and wherein a subject may be located within the interior; the array of cameras being distributed throughout the truss assembly. Also disclosed is a system for capturing three-dimensional images wherein the cameras, lights, and microphones capture the subject from enough angles to generate a three-dimensional virtual model of the subject. Also disclosed is a system for capturing three-dimensional images, wherein the cameras are faced inward to create inverse panoramas. Also disclosed is a system for capturing three-dimensional images wherein the polyhedron shape is selected from the group including: spherical polyhedron, octagonal bifrustum, tetrakaidecahedron, truncated dodecahedron. Also disclosed is a system for capturing three-dimensional images wherein the truss assembly is suspended by way of a suspension truss. Also disclosed is a system for capturing three-dimensional images wherein the truss assembly is suspended over a moving walkway. Also disclosed is a system for capturing three-dimensional images wherein the subject is moving and the truss assembly moves with the subject. Also disclosed are holograms captured using the system disclosed herein that can move through space when played back in alternative reality and virtual reality. Also disclosed is a method for obtaining an enhanced polygraph test. Also disclosed is a method for studying subjects as they interact with virtual spaces and virtual content. Also disclosed is a medical device capturing a subject's movements for the measurement and diagnosis of a medical problem.

Disclosed is a system for capturing three-dimensional images, the system comprising: a truss assembly having a truss frame, the truss assembly coupled to an array of microscopes, wherein the truss assembly may be of a polyhedron shape defining an open area where a subject may be located. Also disclosed is a system for capturing three-dimensional images wherein the microscopes are digital microscopes each having a microscope camera. Also disclosed is a system for capturing three-dimensional images wherein the digital microscopes may be moved towards and away from the subject.

Disclosed is a system for capturing three-dimensional images, the system comprising: a plurality of drones aligned in a polyhedron shape defining an open area where a subject may be located, each drone of the plurality of drones having a camera. Also disclosed is a system for capturing three-dimensional images wherein the plurality of drones are configured to capture the subject from enough angles to generate a three-dimensional virtual model of every frame. Also disclosed is a method for storing, transporting, and charging the plurality of drones. Also disclosed are holograms captured using the systems and methods herein that can move through space when played back in alternative reality and virtual reality. Also disclosed is a method for identifying, cataloging, and tracking individual plants in a crop using the systems disclosed herein.

Other advantages and/or advantageous features will become apparent to those skilled in the art, once the disclosure has been more fully shown or described. Such outlining of advantageous features is not to be construed as a limitation of applicant's disclosure but are merely aimed to suggest some of the many benefits that may be realized by the apparatus and method of the present application and with its many embodiments.

### BRIEF DESCRIPTION OF DRAWINGS

Various examples of embodiments of the systems, devices, and methods according to this invention will be described in detail, with reference to the following figures, wherein:

FIG. 1 illustrates a side cross-sectional view of a truss assembly of the system and method herein according to various embodiments;

FIG. 2 illustrates three types of shapes which may be used in various embodiments of a truss assembly of the system and method herein;

FIG. 3 illustrates a side view of a truss assembly of the system and method herein according to various embodiments;

FIG. 4 illustrates a top view of a truss assembly of the system and method herein according to various embodiments;

FIG. 5 illustrates another side view of a truss assembly of the system and method herein according to various embodiments;

FIG. 6 illustrates a truss assembly of the system and method including a moving walkway or stage according to various embodiments;

FIG. 7 illustrates a number of scoop doors for use with the system and method according to various embodiments;

FIG. 8 shows a drawing of a cross-section of a truss assembly featuring focusing rods;

FIG. 9 shows a detail view of a truss assembly having a number of focusing rods for use with the system and method herein according to various examples of embodiments;

FIG. 10 shows another drawing of a number of focusing rods for use with the system and method herein according to various examples of embodiments;

FIG. 11 illustrates a system and method herein using a transparent stage, according to various embodiments;

FIG. 12 illustrates a “ghost hands on” variant of the system and method herein, according to various examples of embodiments;

FIG. 13 illustrates a variation of the system and method herein for use with a number of drones, according to various examples of embodiments.

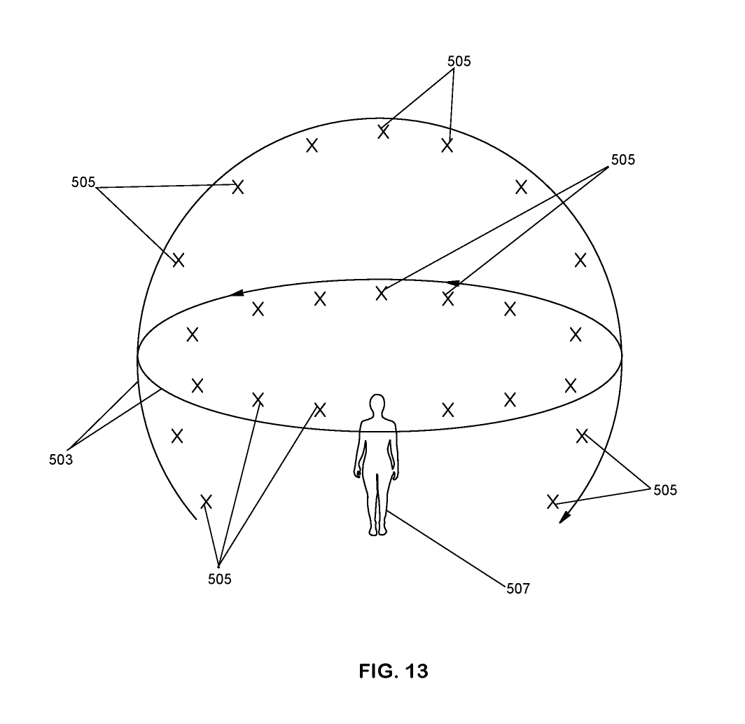

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

Referring to the Figures, a three-dimensional image capturing system and method for capturing three-dimensional images is provided.

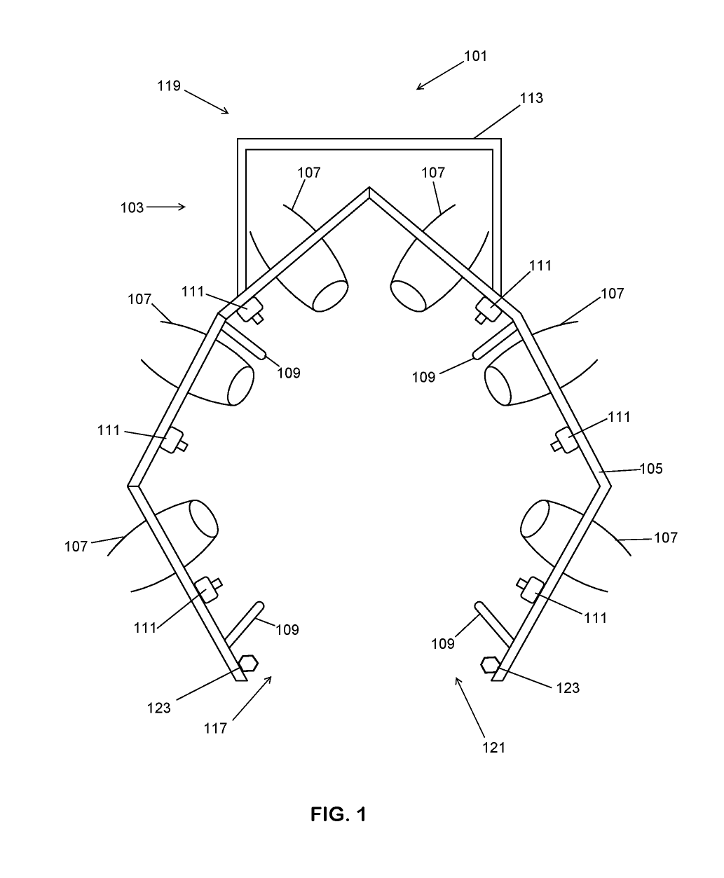

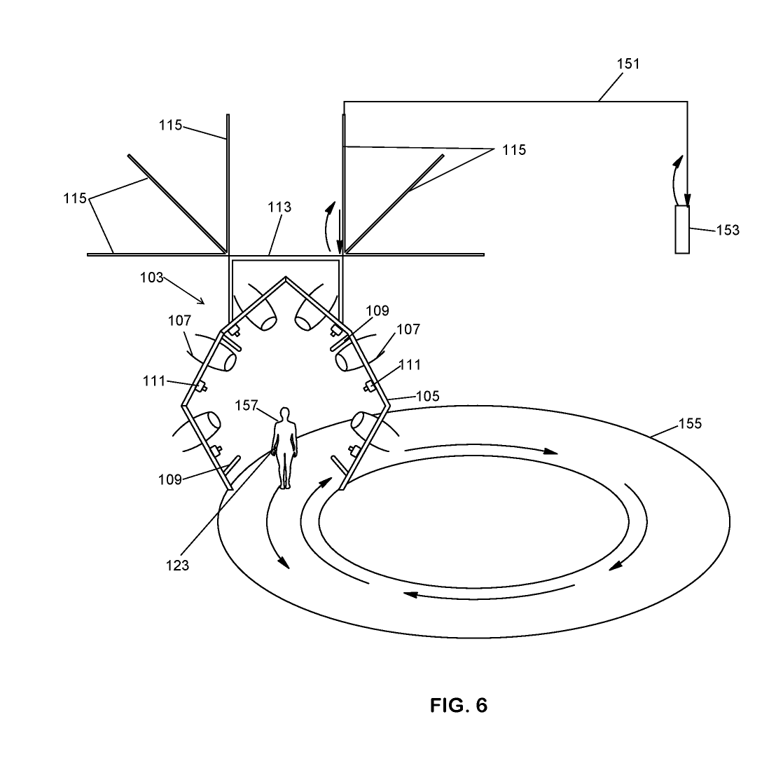

FIG. 1 shows a first cross-sectional view of a three-dimensional image capturing system 101 for including a truss assembly 103 for capturing three-dimensional images, according to various examples of embodiments. In various embodiments, the system may include a truss assembly 103 coupled to an array of cameras 111, lights 107, microphones 109 and tracking devices 123. As shown, the tracking devices 123 could be located on truss 103. Alternatively, tracking devices 123 could be located inside the treadmill or rotating stage 155. In various embodiments, tracking devices 123 could be worn by the subject 157 (in the manner of a smart watch (see FIG. 6)). The truss assembly 103 may be of a spherical polyhedron shape, in various embodiments of the invention (though additional truss assembly 103 shapes should be contemplated within the scope of this disclosure). The truss assembly 103 may be configured or arranged in such a way that one or more subjects are captured from enough angles to generate a three-dimensional virtual model of every frame. In various embodiments, the cameras 111 may be faced inward, creating inverse panoramas. The image capturing capability may be similar to a compound eye.

The size, number of cameras 111, and number of other hardware may be highly dependent on the application for which the system and method is used. In various embodiments, the truss, truss assembly 103, scale, and resolution all affect the number of cameras 111. For example, an application including a number of microscopes 233 as disclosed herein may be much smaller and contain far fewer cameras 111 than a large gantry crane setup which could potentially contain hundreds or thousands of cameras 111. In various embodiments, the system and method herein may be used to capture very large objects and occurrences. As a non-limiting example, the Seawise Giant was an oil tanker that was 1,504.1 ft long. If it still existed, it would theoretically be possible to capture a holographic video of it using the system and method herein, for example, with a number of drones using the system and method herein. In that example, it might take tens of thousands of cameras 111 and/or drones 505 to create a large enough panorama to allow the entire holographic image to be stitched together. A wide range of variants should be contemplated within the scope of this disclosure.

In various embodiments, one or more cameras 111 and/or microphones 109 may be provided on each truss assembly 103 vertex, edge, and/or face, or otherwise at regular (e.g., spatial) intervals. While general three-dimensional shapes may be described for purposes of example, the truss assembly 103 shape may be understood to comprise each edge of each face of the three dimensional shape described. In other words, a truss beam may comprise each edge of a three-dimensional shape of a truss frame 105 suitable for use with the truss assembly 103 described herein.

The truss assembly 103 may be understood to incorporate in various embodiments an array of cameras 111, lights 107, microphones 109 and tracking devices 123. These devices (111, 107, 109, 123) may be arranged within the truss assembly 103 and the frame 105 in such a way that a subject 157 (or subjects) may be captured from enough angles to generate a 3D virtual model. Microphones 109 and lights 107 may similarly be distributed across the truss assembly 103 in order to comprehensively capture movement, sound, actions, and the like. The truss assembly 103 may be part of a system capable of adjusting audio levels, light levels, and robotic camera controls. In addition, the system 101 (which also comprises the truss assembly 103) may be configured to store the information generated by the assembly 103.

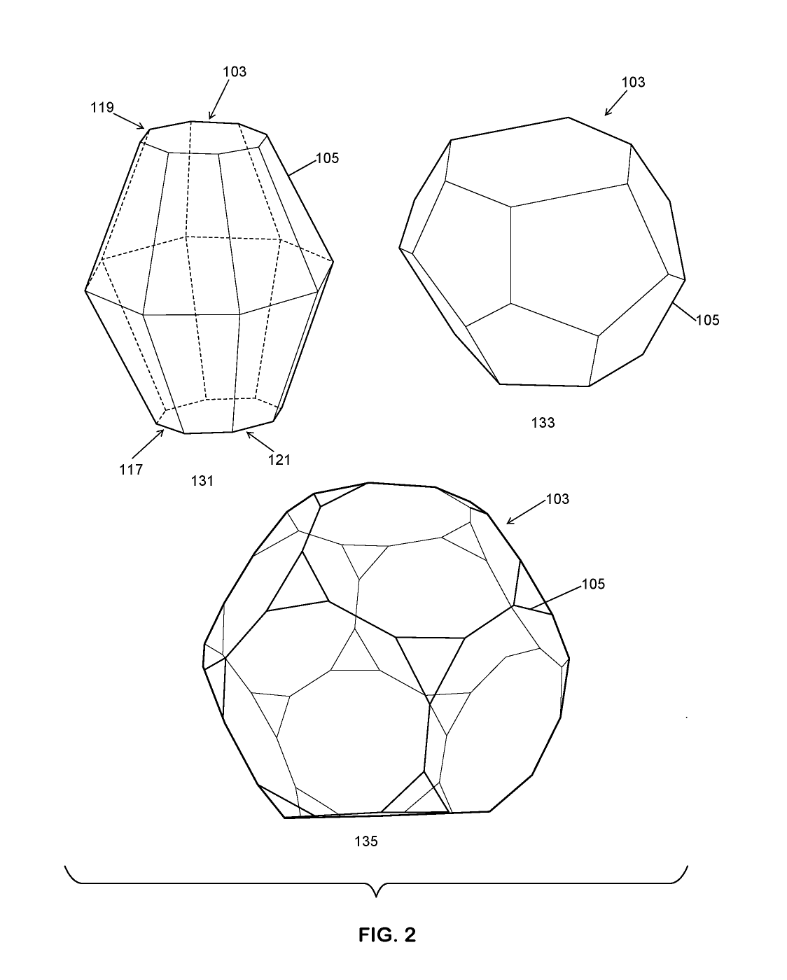

While a two-dimensional cutaway rendering of the system for capturing three-dimensional images 101 is illustrated in FIG. 1, the assembly 103 may be configured in a suitable three-dimensional shape such as (but not limited to) a polyhedron and more specifically spherical polyhedron shape. For example, FIG. 2 illustrates a number of non-limiting types of spherical polyhedron shapes which may be used with the system and method disclosed herein. In various embodiments, the truss assembly 103 may be shaped as an octagonal bifrustum 131, a tetrakaidecahedron 133, or a truncated dodecahedron 135 (variations thereon should be contemplated within the scope of this disclosure). A sphere or sphere with a flat bottom could likewise be used. Variations on shapes of a truss assembly 103 may include a variety of three-dimensional regular or irregular shapes including but not limited to polygons, prisms, spheres, hemispheres, polyhedra (e.g., convex polyhedra, bifrustroms), etc. It will be understood to one of skill in the art that a number of suitable three-dimensional shapes which may be suitable for a truss performing the purposes described herein can be used. In other examples of embodiments, a contiguous three-dimensional truss structure may not be necessary. A variety of structures suitable for performing the functionality disclosed herein should be contemplated within the scope of this disclosure.

The system and method disclosed herein may be deployed in a theater setting. For example the truss assembly 103 may be deployed on existing rigging in a theater setting. One non-limiting example of a suitable theater setting may include a substantially open stage area similar to a standard theater. The system and method herein including the truss assembly 103 may be deployed on a stage with flyspace, suspended from cranes, larger trusses, or any high point capable of supporting the appropriate weight. Inside a theater, in various embodiments, the truss assembly 103 may be suspended from the grid or battens and connected to existing power supplies and equipment. Deployment inside a theater of the truss assembly 103 may allow for greater control over lighting and sound while also allowing for access to a suitable floor for movement during use of the system and method herein. Deployment of the system and method herein in a theater may also allow for use of the theater downtime by filling underutilized spaces with content creators (for example, three-dimensional imaging content creators).

The truss assembly 103 framework or truss frame 105 may have a similar base structure as a touring truss. The truss frame 105 for use with the system and method herein may allow for integration of wiring for all hardware (cameras 111, microphones 109, lights 107, etc.). In various embodiments, the truss assembly 103 according to the system and method herein may use “stage snakes” for connecting the wiring together for easy patching to remote control and recording. In various embodiments, the truss assembly 103 is easily collapsible for easy storage. The truss assembly 103 may protect the cameras 111 when disassembled (e.g., similar to a touring truss). The truss assembly 103 may be stored for ease of mobility. Storage may be performed for example in rolling cases or a flyspace. The flyspace may comprise polygon rings suspended from a single batten.

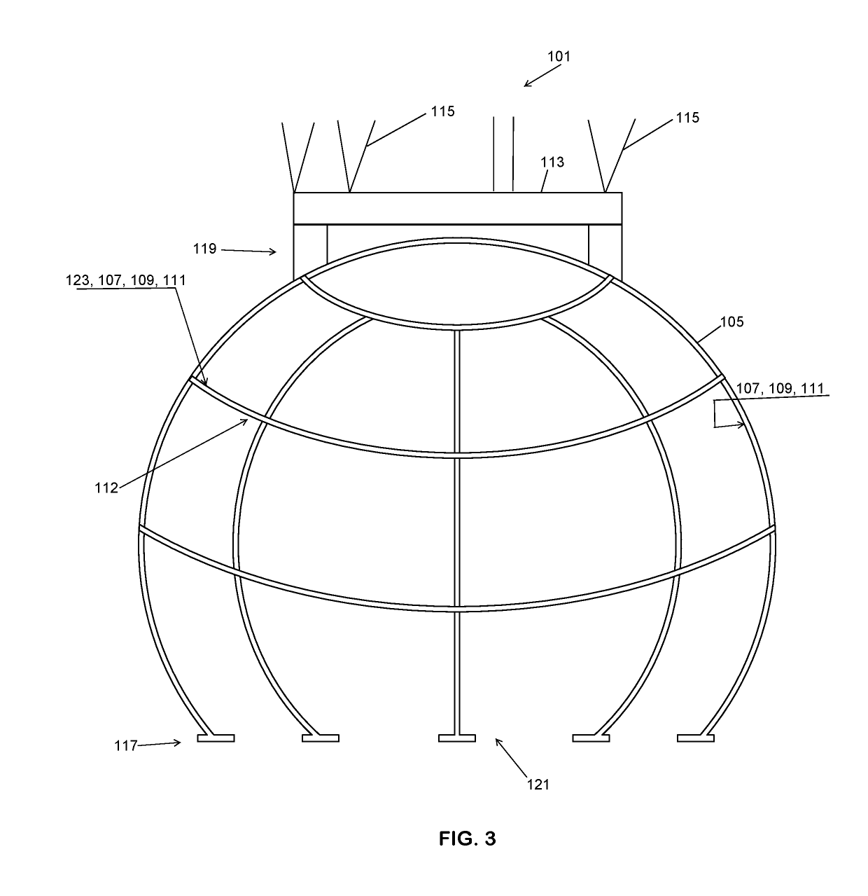

FIG. 3 shows a side view of the truss system 103 according to various examples of embodiments. The truss assembly 103 may include a camerasphere 112, suspension truss 105, and rigging. The camerasphere 112 may be understood to describe the provision of cameras 111 throughout the truss assembly 103. The truss assembly 103 may further comprise a suspension truss 113 and rigging 115 for suspension of the truss assembly 103. The suspension of the truss assembly 103 may allow for movement of the truss assembly 103. While the suspension truss 113 may be shown on top of the sphere (or top of the truss assembly 103), alternative locations (sides, bottom) may be contemplated as within the scope of this disclosure.

The truss assembly 103 may be hung from a system which allows movement. In various embodiments, the truss assembly 103 may be hung using a suspension truss 113. The truss assembly 103 may be moved, in various embodiments, using a robotic cable gantry system, manual stagecraft flying, or a claw game-type apparatus. An example robotic cable gantry system suitable for use with the system and method herein may be seen in the Max Planck Institute virtual reality simulator. The system 101 including the truss assembly 103 could also accomplish movement by way of a digital tether that allows the truss assembly 103 to automatically and precisely follow the subject or subjects. The system and method herein may also include a moving contraption such as a technodolly or other motion control devices. The technodolly may, in various embodiments, act as a crane to move the truss assembly 103. In addition, control software may be provided which allows for switching between one or more subjects to be followed. Thus, movement of the truss assembly 103 may be automated or manual.

The size of the truss assembly 103 may be large enough to accommodate action, multiple subjects, and set pieces, among other features. The truss assembly 103 may be moved to keep the subject(s) centered. The truss assembly 103 may be deployed on a stage from existing rigging 115. In various embodiments, the truss assembly 103 may be deployed from any high point strong enough hold its weight. The truss assembly 103 may be suspended from objects that are or can move, such as a crane, mast, drone 505, helicopters, or other suitable moving device able to withstand the weight of the truss assembly 103.

In one or more embodiments of the system and method herein, the truss assembly 103 could be suspended from or embedded in the walls of contraptions similar to one or more mobile gantry cranes. In addition, the truss assembly 103 may be mounted (e.g., mounted directly) onto a support structure (e.g., the mobile gantry cranes). Drydocks, floating drydocks, and heavy lift ships may also be used, in various embodiments of the invention.

The truss assembly 103 may be suspended from above (top 119) and open at the bottom 117 (opening 121) (though other arrangements may be within the scope of this disclosure). The truss assembly 103 may, in various embodiments, be capable of motion on the X, Y, and Z axis; rotation may be provided using robotic, automated, or manual means. The truss assembly 103 may move to keep a subject or subjects 157 centered within the truss assembly 103, in various embodiments of the invention.

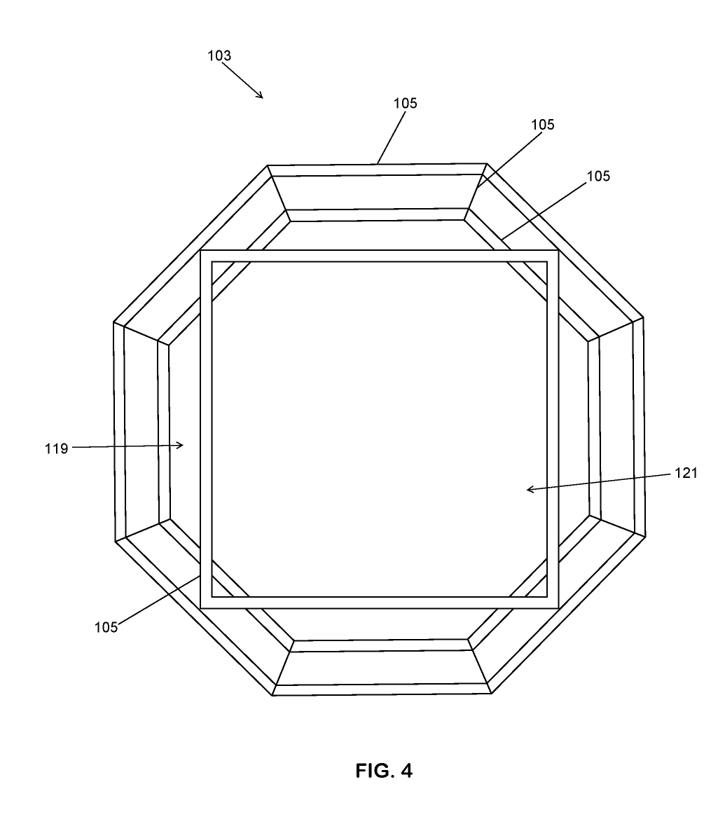

FIG. 4 shows a top 119 view of the truss assembly 103, according to various examples of embodiments. The truss assembly 103 may be comprised of a number of truss rings, according to various embodiments. The truss rings may be polygonal, for example, an octagonal truss ring. The truss rings may feature a number of cameras 111, microphones 109, lights 107, and/or movement sensors 123, which may be in spaced relation to each other. The sensors 123, cameras 111, microphones 109, and lights 107 may stay fixed—in relation to each other—on the truss assembly 103, even as it moves. In various embodiments, multiple 360 degree camera rings 125 (truss rings) are suspended at strategic points throughout the truss assembly 103. The rings 125 may be arranged such that the cameras 111 mounted thereon obtain multiple inverted panoramas horizontally and near or approximately 360 degree vertical inverted panoramas without occlusions.

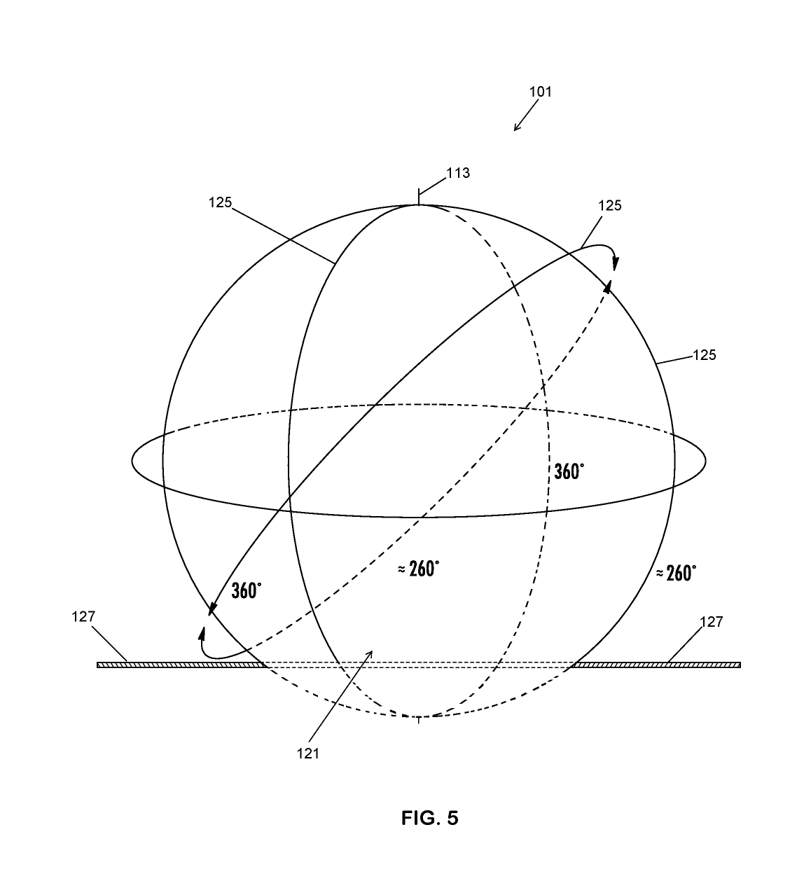

FIG. 5 shows a side view of the truss assembly 103 according to various examples of embodiments. The truss assembly 103 may be capable of capturing approximately 360 degree by approximately 260 degree audio and visual images from a suspended (e.g., suspended from above or other location) truss system using a suspension truss 113. The suspended truss system may further comprise microphones 109, lights 107, and/or cameras 111 (i.e., microphones 109, lights 107, and/or cameras 111 may be embedded, fastened, or coupled to the truss frame 105). In various embodiments, the microphones 109, lights 107, and/or cameras 111 may be attached in multiple vertically-stacked rings (though vertically-stacked rings are discussed, variations thereon should be contemplated as within the scope of this disclosure, for example, radially stacking, objects, single rings, or other suitable arrangements). The hardware (in various embodiments including microphones 109, lights 107, and/or cameras 111) may be mounted directly onto the truss frame 105. The hardware may be faced inward, towards a center of truss assembly 103 for capturing audio and/or video.

The bottom 117 of the truss assembly 103, in various embodiments, may remain open 121 so that it can travel flush with the floor 127 and accommodate a horizontal truss ring (e.g., a 360 degree camera ring 125) as close to the floor as possible. There may, in various embodiments be small spaces in the truss assembly 103 through which subjects 157 and set pieces can pass through horizontally without interrupting the continuous truss frame 105 rings or camera rings 125. Therefore, the approximate 360 degree vertical panorama becomes roughly 260 degrees in various embodiments because the truss bottom 117 (floor 127) may not be captured (the truss assembly 103 should be understood in various embodiments to acquire 360 degrees and 260 degrees simultaneously, as illustrated further according to various embodiments in FIG. 5).

Movement in and out of the system 101 by individuals and objects may be facilitated by small side openings, in various embodiments. The openings may allow for maintenance of a full 360 degrees of recording or image capturing capability in various embodiments.

A truss (truss assembly 103) of the system disclosed herein may allow for inversion, i.e., upside-down positioning, in order to “fly” in and out (remove and allow entry of) subjects or individuals. In various embodiments the truss assembly 103 could also have wheels or possibly be suspended from a heavy “lift” drone or helicopters.

The system and method herein including the truss assembly 103 may allow for 360 degrees by 260 degrees images of a subject in motion by flying (in the theater sense or suspended from an aircraft) over a subject or subjects. The imaging ability may allow, in various embodiments, for video from which three-dimensional models can be taken for three-dimensional printing from every frame. In other words, the captured video may be paused at any point and the frame used to render a three-dimensional print. In addition, the system and method herein including a truss assembly 103 may allow for the capture of three-dimensional audio to be captured of subjects in motion. The audio capture may likewise be accomplished by “flying” microphones 109 over the subject or subjects.

FIG. 6 shows a truss assembly 103 surrounding a moving space 155, according to various embodiments. A direction of rotation is shown. The truss assembly 103 may surround a moving space, in various embodiments. For example, the moving space 155 may comprise a rotating stage, treadmill, omnidirectional treadmill, stationary swimming pool, ship model basin, or other suitable moving surface or space. As a non-limiting example, the system and method for capturing three-dimensional images herein could be used to capture a fashion show catwalk. For example, subjects 157 in a fashion show walking on rotating stages or treadmills while inside a truss assembly 103 could create the illusion of moving holograms. The resulting footage could be used to produce a virtual reality or augmented reality fashion show. The truss assembly 103 of FIG. 6 likewise includes a stage snake 151 and control center 153 which may be used for data processing and system operation.

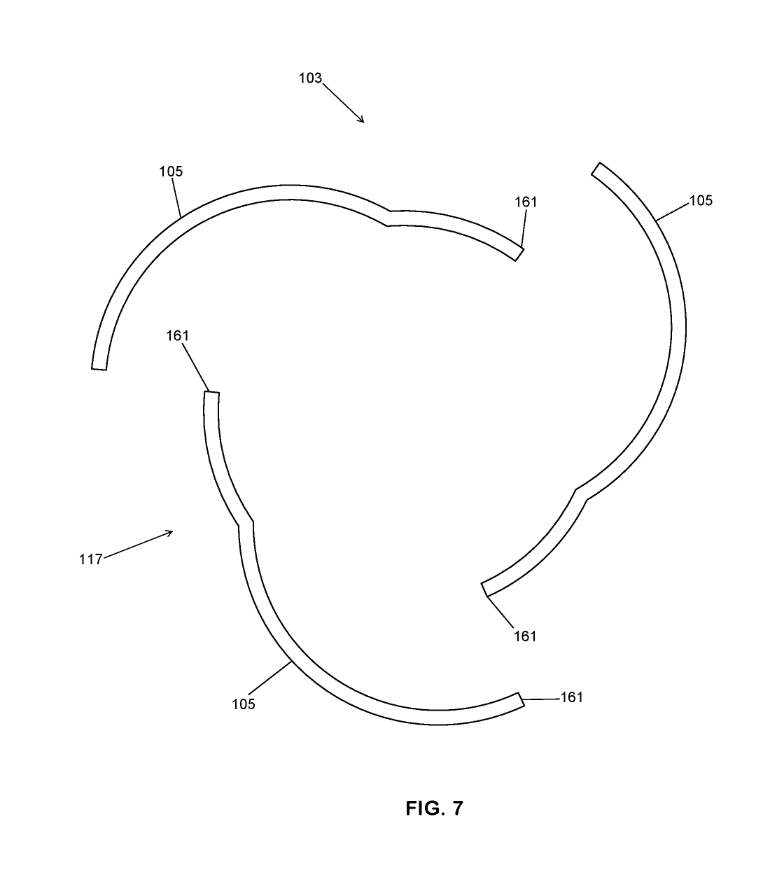

FIG. 7 shows a truss assembly 103 having “scoop doors” 161 according to various embodiments. In various embodiments, an opening 121 may exist in the side of a truss assembly 103. The opening 121 may resemble a partially-peeled orange (wherein part of the truss assembly 103 is peeled open). The partially separated “peel” (section of truss assembly 103) may be opened and may be seen extended behind the “unpeeled” section (a remainder of the truss assembly 103) to provide full coverage as if the “peel” was still complete (the truss assembly 103 were still contiguous). By rotating the truss assembly 103, truss assembly 103 may, in various embodiments, be transformed into a revolving door capable of engulfing objects while maintaining a substantially 360° by 260° inverted panorama. In doing so, the shape of the truss assembly 103 does not change and the sensors 123 remain in fixed positions in relation to one another. Instead of a door opening or closing to allow objects in, the truss assembly 103 rotates to allow entrances or exits without occlusion (i.e., interference with capturing the three-dimensional image using, for example, cameras 111, lights 107, and microphones 109).

Various additional components may be contemplated as within the scope of the system and method herein, in various embodiments. A digital tether may be attached to subjects 157 allowing for the truss assembly 103 to follow the subject in motion and cut away to other subjects upon direction; this may comprise, in various embodiments, an automated cutaway switch. The system 101 may also comprise a careful coordination of all camera frame rates within the truss assembly 103, in various embodiments, to obtain a highest possible resolution which may be used for three-dimensional modeling. A robotic cable gantry system may also be included in the system and method herein; the robotic cable gantry system may automate truss assembly 103 movements and coordinate with automated cutaway switch directions. Stitching software may also be included in the system and method herein; the stitching software may “stitch” the images together from the respective cameras. In various embodiments, the frames may be synchronized across the truss 103 from each capturing device.

### Cameras

In various embodiments of the system and method herein, multiple 360 camera rings 125 may be suspended at strategic points throughout the truss assembly 103 frame 105. The positioning of the cameras 111 may be such that multiple inverted panorama images may be obtained horizontally and near 360 degree vertical inverted panorama images may be obtained without occlusions. All of the cameras 111 may be tethered into the same system, in various embodiments, (e.g., for power, control, and data). The cameras 111 may remain fixed in relation to one another as the truss assembly 103 travels around subjects 157 or the subjects travel below on moving mediums. All wiring for the cameras 111 may be stage snaked together and routed to a capture station. The capture station may be a part of the system and method herein utilized for storage and processing of the obtained three-dimensional images, audio, and data. The cameras 111 may be situated between one-way mirrors or one-way video displays.

### Lighting

In various embodiments, the truss assembly 103 may comprise a plurality of lights 107. The lights 107 may be mounted on the truss assembly 103 to prevent shadows and occlusions to cameras or microphones 109. The lights 107 may have fully coordinated tethered control and power. The lights 107 may be stage snaked 151 together and routed to a light board. The lights 107 may allow for 360 degree inverted light panorama for full light and shadow control on all sides of the subject (or subjects) simultaneously.

### Sound

In various embodiments, the truss assembly 103 may comprise multiple microphones 109 situated at strategic points to capture 360 degree three-dimensional audio. The microphones 109 may, in various embodiments, be coupled around an interior of the truss assembly 103, for example, on truss frame 105, without blocking cameras or lights, or likewise being blocked by cameras 111 or lights 107. The microphones 109 may likewise be stage snaked together and routed to a soundboard for three-dimensional audio recording.

### Network

The system 100 and method herein may also include a network component. The network may power and control microphones 109, cameras 111, lights 107, and truss assembly 103 motion, among other components of the system and method herein. The network may likewise deliver data from these components to controlling, recording, and/or broadcasting device(s). In various embodiments, the network may employ power over Ethernet technology. The network or network component may likewise be neatly stage snaked for quick and easy disassembly and storage while preventing tangling during use.

### Microscope Variant

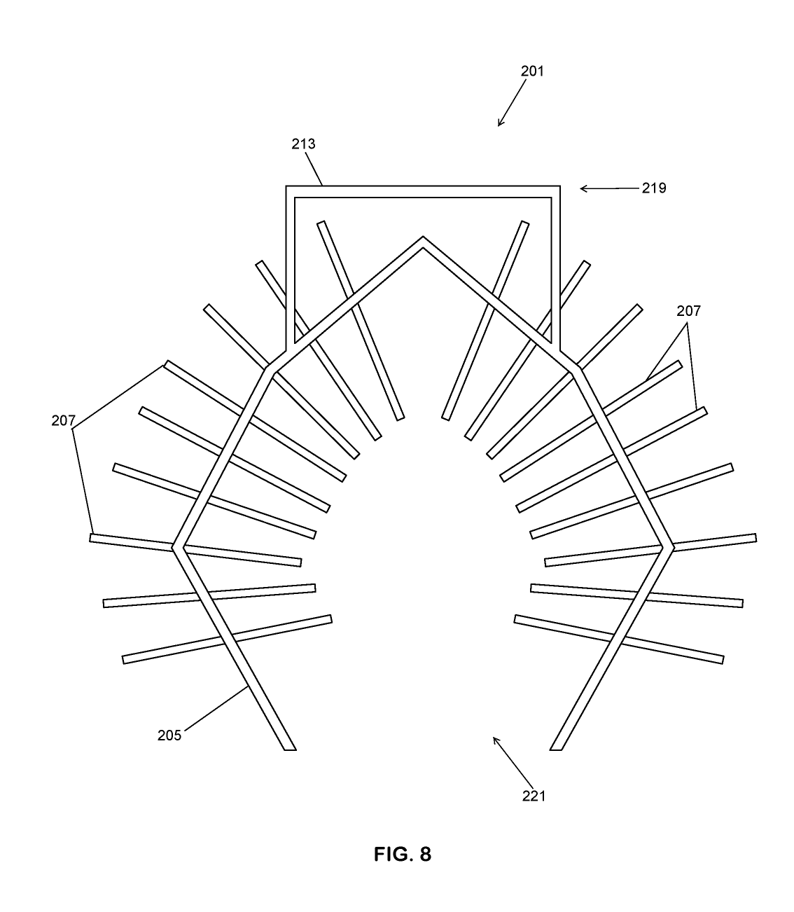

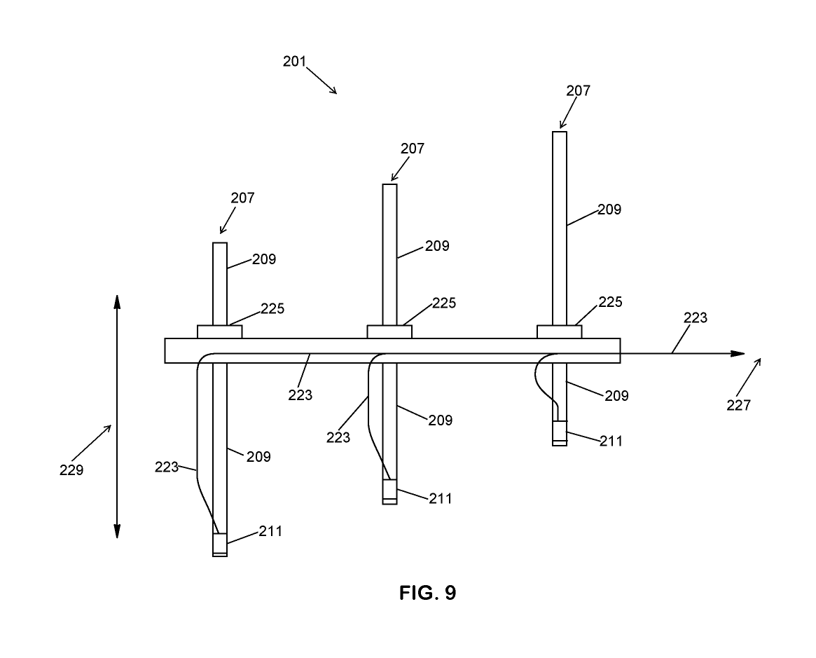

The system and method herein including the truss assembly 103 may be scaled down to the level of microscopes in various embodiments of the invention. This functionality may be enabled, in various embodiments by customizing the truss assembly 103 to support an inverted panorama of microscope 211 heads. FIGS. 8-10 show various embodiments of use of a three-dimensional image capturing system 201 and method herein with focusing rods 207. In various embodiments, a truss assembly 203 may include a series of focusing rods 207 arranged like a sea urchin inside the truss assembly 203. In this arrangement, a digital or USB microscope 211 may be allowed to focus in and out by sliding toward and away a subject or subjects provided in the center of the truss assembly 103 which may be accessible by an opening 221. The digital microscope 211 may be provided in the truss frame 205; the truss frame 205 may be supported using a suspension truss 213. In various embodiments, the suspension truss 213 may be provided at a top 219 of the truss assembly 203. FIG. 8 shows a cross-sectional view of a focusing rod 209 variant, according to various embodiments. FIG. 9 shows a detail view of three focusing rods 207 having three different depths. The focusing rods 207 may be seen on a truss assembly 203 (the term “truss assembly 203” should be understood to encompass a “spherical polyhedron truss” or “SPT”). Digital microscopes 211 may be provided on the ends of the focusing rods 207. A focusing depth adjuster 225 may also be provided. The focusing depth adjuster 225 may be robotic or analog, according to various embodiments of the invention. Data and power cabling 223 to a stage snake 227 may also be provided. The microscope cameras 233 or the system and method herein may be powered by power over Ethernet, in various embodiments. The focus rod 209 may travel toward and away from the subject or subjects.

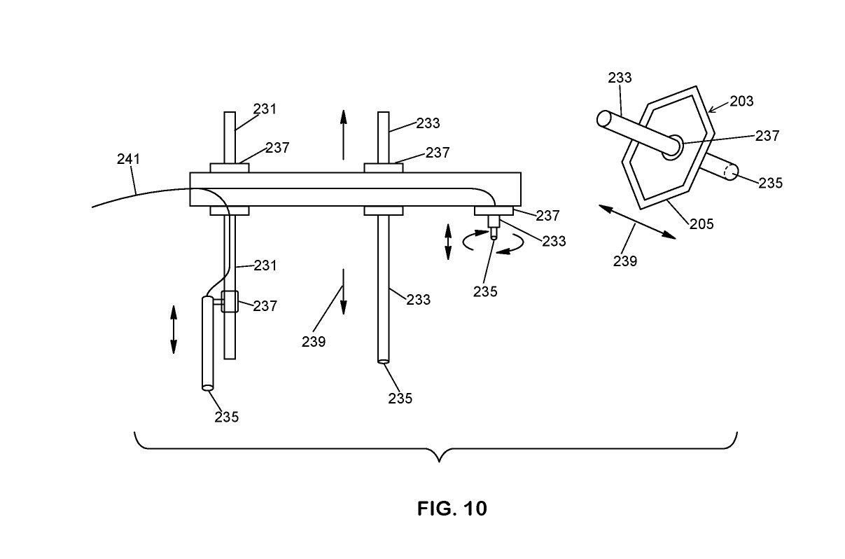

FIG. 10 shows a number of focusing rods in a variety of mount types. The microscope (focusing rods 207, focus rods 209 including a microscope camera 233) may be seen provided in a number of stand types. In a first example, a lab stand variant may be used. This variant may allow for focusing by traveling toward and away from the subject; the lab stand rod may adjust pan and tilt. In a second example, a zoom-through clamp having a clamp adjuster 237 and lab stand pipe 231 may be used; the clamp may focus by traveling toward and away from the subject (motion 229) by also moving through the clamp. The clamp 237 may also adjust pan and tilt and clamp onto the truss frame 205. In a third example, a telescoping PTZ may be used; the mount may allow for a fixed position on the truss frame 205, and control the PTZ from afar. In a fourth example, a facet type may be used; zooming may be accomplished through the truss assembly 103 facet, including clamp pans and tilts. While such examples are explained in the context of a microscope variant of the system and method herein, it should be understood such capabilities may be extended to all sizes or variations of the system and method herein. For example, a telescoping PTZ may be used in various embodiments of the system and method herein, such as with one or more full-sized cameras 111 in a truss assembly 103.

On some variants of the system and method herein, a microscope 211 could mount directly onto the truss assembly 203 or truss frame 205. In other embodiments, the microscopes could be attached onto a series of adjustable rods by which they could focus by traveling toward and away (motion 229) from the subject(s) (i.e., using a focusing depth adjuster 225). Therefore, some embodiments may be divided between a mounting-type arrangement and a focus-type arrangement. The mounting-type variants may include a lab stand mount 231, a PTZ through clamp, and a facet type mount. The focus-type variants may include a lab stand version, a telescoping PTZ, a plus/minus extension type, and a PTZ through variant. Examples of suitable mounts may include an Edmunds optics usb microscope mounted on a lab stand. Necessary wiring 241 could be provided to facilitate imaging or data transmission

### Transparent Stages Variant

In addition to an opaque stage, the system for capturing three dimensional images 301 and method herein may be situated in different configurations relative to differently shaped transparent stages 305 such as petri dishes, knucklebone (jacks) shaped growth medium. This ability may advantageously allow for recording the spread of life in three dimensions.

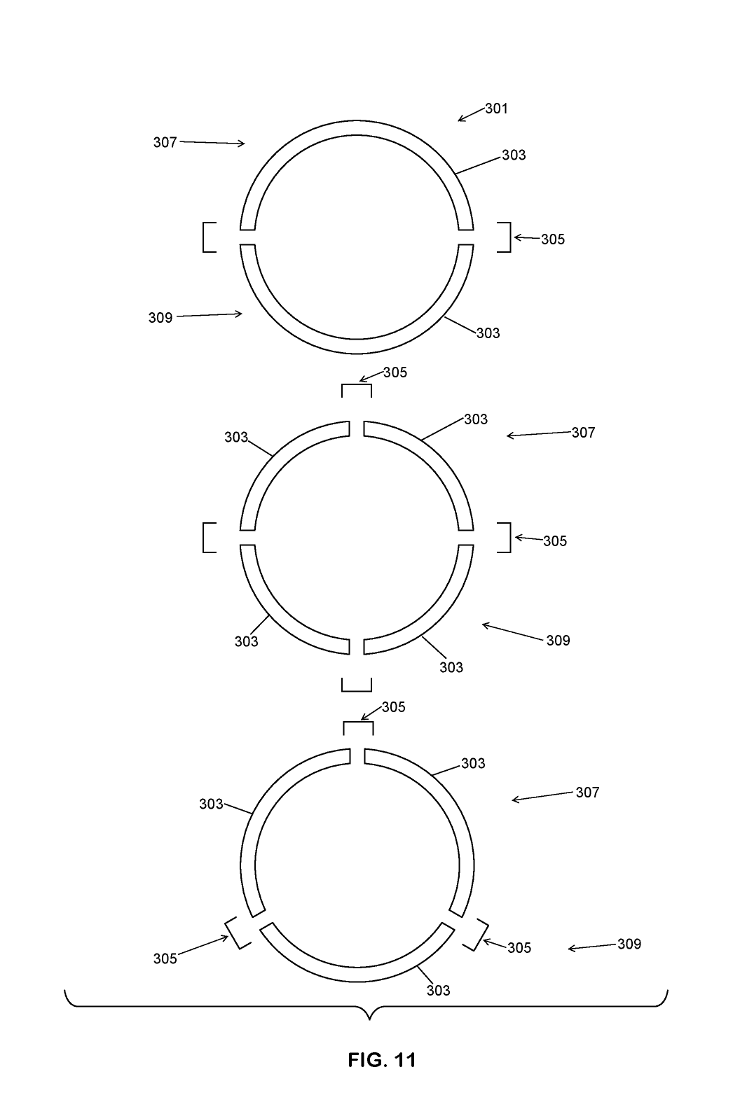

FIG. 11 shows a number of variations of the system and method herein including the use of transparent stages 305. In a first version, a transparent stage is shown dividing the truss assembly 303 (or truss assemblies 303) into approximately equal halves (top 307, bottom 309). In a second version, one or more transparent stages are shown dividing a truss assembly 303 (or multiple truss assemblies) into approximately equal quarters along both an X and Y axis. In a third example, transparent stages 305 are shown dividing one or more truss assemblies 303 into three sections. It should be likewise understood FIG. 11 illustrates a number of different shapes which may be suitable for creation of a truss for use with the system herein, according to various examples of embodiments. For example, the truss 303 may be formed of various odd shapes which may form an inverse panorama.

### “Ghost Hands” System

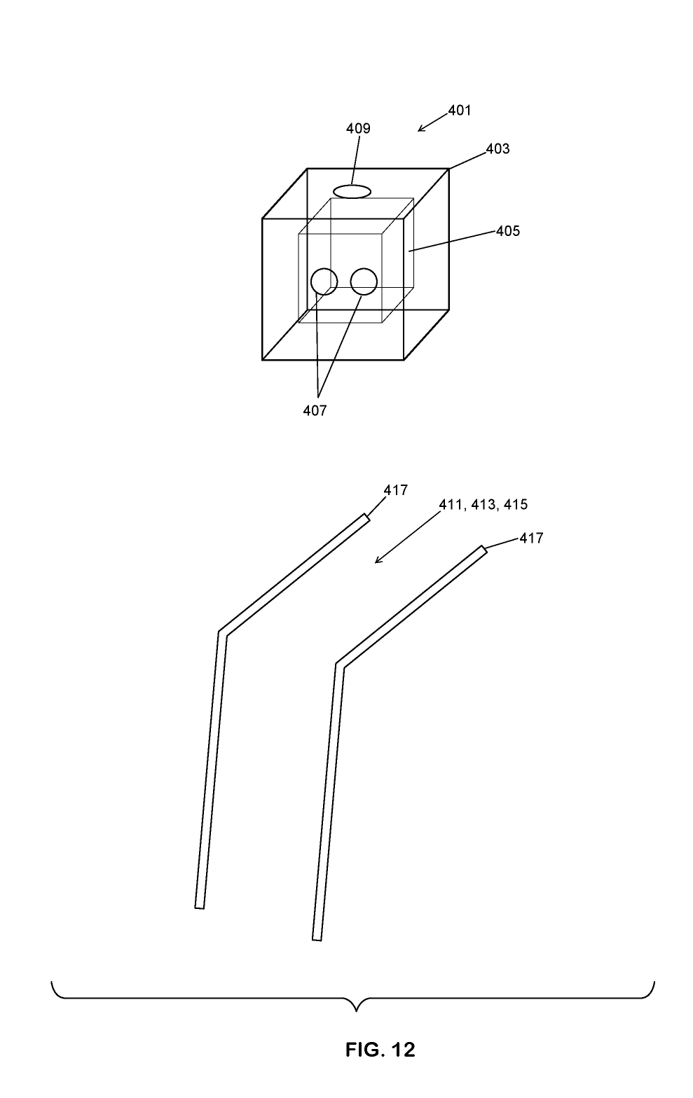

The system and method herein may also comprise a “ghost hands on” system for capturing three-dimensional images 401. The system may allow for collection of hands-on holographic videos. In various embodiments, the truss assembly 403 may be constructed from a transparent material such as glass or lexan. Construction using transparent materials may allow for user visibility into what their hands are doing through its transparent structure. In addition, the truss assembly 403 in this embodiment may have openings 407 for allowing a user's hands inside the assembly 405 in a manner of a glove box. The system and method may be lowered onto tables or stands wherein the system may become a drafting table, biosafety cabinet, laminar flow cabinet, fume hood, exhaust hood, work bench, etc. Additional applications could include on an assembly line or over a body. An example of this configuration may be seen according to various embodiments in FIG. 12. In addition, the system may also have a means of venting 409 the enclosed truss assembly 403 to prevent condensation, contamination, and fume buildup. The system including the truss assembly 403 could, if light enough, be lifted by a user for transportation or suspended from above or resituated as needed. The table upon which the system may rest, in various embodiments, could itself be an inverted truss assembly 103, creating a full 360 degrees by 360 degrees hands-on holographic video. In various embodiments, odors could likewise be captured in addition to the system and method herein. The system 401 may further comprise a number of transparent layers 417 which may define the truss 403 and internal assembly 405 and further comprise one or more lights 413, cameras 411, and microphones 415.

### “Drone Swarm” Variant

FIG. 16 shows various embodiments of a three-dimensional image and audio capturing system using drones 501. In various embodiments, the truss assembly 103 may be generated by a number of drones 505 to create a drone assembly 503. In other words, a physical truss assembly 103 may be replaced with a digital one 503. Drones 505 may be deployed around the subject in sufficient numbers to obtain an inverse panorama of videos, light, sound and/or tracking. The drones may therefore be individually equipped with (comprise) one or more cameras, lights, sensors, microphones, and the like. Using human or computerized control, the drone swarm “truss assembly 503” may surround the moving subject 507 as one, capturing data for the creation of a holographic experience. The drones could, in various embodiments, be tethered to one or more wearables such as smartphones, smart watches, wireless microphones, motion capture contraptions, etc.

### Guided Deselection

One example of a drone swarm variant can be understood as “guided deselection.” In this example, sixteen drones 505 may fly in a spherical polyhedron formation with their high resolution cameras facing inward in the manner of an inverse panorama are able to capture the subjects (in this case plants) in the center as a 3D virtual models. The “guided deselection” drone swarm could travel along each row after planting to create a virtual model of every individual plant in each row for storage and analysis throughout the plants growth cycle. This may constitute a new type of specific remote sensing that can be utilized repeatedly and affordably to capture the growth stages of individual plants over time across the massive scale of row crops. Imagery from all sixteen (while sixteen is specified, more or less may be constituted as within the scope of this disclosure) drones may be stitched together after each flyover creating a virtual model of every frame. New computation techniques could be developed to identify, catalog and track each individual plant in the row using an automated process as it grows. Scientists, crowdsourcing and machine learning could identify unwanted traits using an automated process. Over time, the algorithms developed could also predict which individual plants to cull based on their growth patterns, unfavorable response to conditions, delayed germination, etc. Plants that do not satisfy chosen traits for artificial selection can be identified using an automated process based on the virtual model of each plant that is collected by the system for capturing three dimensional images 501. Using an augmented reality headset such as the HoloLens, workers could enter the field and cull the plants identified to have unfortunate traits before mating age, thus increasing the positive selective pressures by thoroughly eradicating unwanted traits from large row crop gene pools (i.e., drain the gene pool from the bottom). HoloLens equipped workers following the virtual models created with system 501 may be more efficient at interacting with specific individual plants, much more thorough in culling unwanted organisms before breeding and would also be able to remove novel organisms for transplanting, controlled mating or genetic testing. Advantages could include increasing the scale and efficiency of artificial selection in plant breeding and increasing the scale of a gene pool filter for example, in one or more embodiments, by allowing hyper specific trait targeting over huge row crop areas at extremely high resolution (down to each individual plant).

Like a person standing in reality and viewing virtual content with the HoloLens augmented reality device, workers in farm fields may, in various embodiments, be able to view virtual information about every plant in an area while standing in the field, allowing them to make actionable decisions with the information provided. Unwanted plants, for example, could be culled before breeding based on unfortunate traits they show early on (up until booting in cereal crops).

AR headset wearing workers could also extract novel specimens (as identified by the automated process) for transplanting, controlled mating, genetic testing, etc. The system could provide regularly updated actionable data about pests, water management, stresses and other problems at the scale of individual plants. In various embodiments, the plants that survive culling could perform better because they are not competing for nutrients with unwanted organisms, furthering increasing positive selective pressures.

In various embodiments, mass spectrometers could remotely sense individual plants over large areas in 3D for isotopic labeling of an entire row crop. Multispectral imaging could, in some embodiments, remotely sense individual plants in 3D, revealing new information. Collecting and analyzing data over time could also be very beneficial to breeders because each organism could be tracked generation after generation on the massive scale of a row crop setting. Planters could theoretically be constructed that allowed farmers to track individual seeds to capture the full life cycle over time. AR headset wearing workers could apply pest interventions based on the information their devices provided.

The system 505 could also exist at the microscopic scale (not as drones but mounted on trusses). It might be possible to develop a system that allowed for the study of cheese-making fungi, fermentation yeasts and pharmaceutical drug making microorganisms using the same strategies.

After the crops have been harvested, in various embodiments, individuals wearing AR headsets could return to the same field and view each plant as a 3D hologram. The growing season could be replayed—down to each individual plant—with imagery from every flyby showing the progression over time, for example. This could provide advantages for education and advocacy. This could include explanation of the Feekes and Zadoks scales; possible farm tourism revenue; and virtual reality haunted farm businesses.

In various embodiments, the system 505 uses a drone hangar that may comprise a trailer, shipping container, silo or grain bin with a type of aperture (such as, but not limited to, an automated garage door) through which the swarm can travel. In various embodiments, the aperture may be suitably sized for passage of one or more drones. In a preferred embodiment, the aperture may be opened or closed automatically. The drone hanger may comprise, in various embodiments, a containerized drone hangar. The containerized drone hanger may feature at least one aperture on every facet of the container so that drones can still pass through when they are stacked or when they are in transport on any mode (e.g., transported on rail, ship, or trailer). This may be understood, in various embodiments, as a “droneway” that allows x, y, and z travel by unmanned aerial vehicles (such as drones 505). When stacked, each drone hangar may have its apertures aligned with the apertures of another adjacent drone hangar. In this way, the drones 505 may escape the drone hangar stack through the aligned apertures. The apertures may, in various embodiments, be interoperable with existing lashing gear and conventions. In various embodiments, the hangars and their power terminals are interoperable with reefer container infrastructure. In various embodiments, the disclosed drone hangar may allow for storage of the drones 505 such that they do not need to be manually packed (e.g., the swarm software may direct the drones to fly back into the storage that protects them during intermodal transport). The system 505 including the trailer/shipping container/silo/etc. may include induction charging, wife, solar power, batteries, a weather station and satellite internet uplink which may provide regular imagery refreshes (weather permitting). A professional drone pilot may train the swarm using existing swarm AI software. An FAA exemption may allow for autonomous drone flight so that the drones can repeat the same flight path to gather plant 3D models as needed.

The system 505 as implemented on a field may include one or more posts near the entrance to a field. The posts may act as a vertical axis. Spurs may be provided on the posts to provide horizontal and depth axis (or a Reality Key). The drone flight pathway may capture these posts as part of the overall 3D model of the field. When a user logs into an AR headset device into the field, the user may be presented with a 1:1 scale virtual model of the field (with adjustable opacity) that a user may drag—like the hand tool in existing photo apps—tilt and rotate until user perspective, the AR headset perspective, the virtual model (of the reality key) aligns perfectly with the Reality Key (in actual reality). Next, a combination of GPS, pedometry and/or visual inputs from the AR headset cameras can be compared against the virtual model to maintain positioning down to each individual plant.

Resolution may be provided, in various embodiments, down to each individual plant. This feature may assist in making quick, actionable decisions at a super macro scale. To navigate a field, each plant may constitute one point; each row a line. A polygon may geofence the exterior. A line may appear directing the user to the shortest distance between user location and that point. After syncing with the Reality Key, the AR headset's cameras may use visual recognition (in partnership with GPS and pedometry) to know where the user was in the field and visually convey that information through the headset for navigation and allow the headset to show data about each plant.

In order to control the drones 505 and “truss” 503, an initial setup may occur by an experienced professional drone pilot using a third party swarm software to train the swarm, but over time the whole process could become automated. Setup may occur right after emergence of the plants to be monitored, in other words when the plants are still really small and they can show us exactly were the rows are. The swarm 503 may be trained to form in an inverse panorama with the subject capture area 507 in the center, fly up and down the rows in formation before returning for data collection. Future versions could have mass spectrometers, cameras in many different spectrums, etc. Each drone 505 in the swarm 503 may supply geotagged imagery including heading. The Reality Key could also act as a reference point, line or polygon that the swarm could use to assemble formation.

### Hololocomotion

The medium of moving holograms may be understood as Holocomotion. In other words, Hololocomotion may comprise the media—and the software—necessary to create the playback media allowed from the creation of the systems and methods herein 101, 201, 301, 401, 501.

Hololocomotion may be understood as defining holograms captured in mixed reality that can MOVE through space when played back in AR and VR (not just stationary holograms). This is differentiated from known commercialized mixed reality capture studios as known media is created in a capture prison and cannot move through space. Further, known systems are not presently capable of empowering free range holograms with holocomotion.

Holocomotion hologram software may require understanding of where the user is in space (real or virtual) in relation to the user and the surrounding space (real or virtual) and be able to move accordingly. Holocomotion therefore may also be capable, in various embodiments, of reproducing a subject's spatial movements from the systems disclosed herein into another space (real or virtual) at a 1:1 scale (exact reproduction) or at different scales as adjusted by the user. Not only may this include the subject, but may also include their movements like footsteps, jumps, or dances.

Holocomotion may be likewise understood, in various embodiments, as a playback means for content created by the image capturing system herein.

The system and method herein may enable a number of advantageous applications. For example, the system and method herein, in various embodiments, may allow for “holoportation” (e.g., interaction with holograms of individuals) of moving subjects; three-dimensional printing of each video frame; “direction” by an audience through visibility of all angles; distributed holoporation theater events in which live actors interact with actors holoported to their location from another point in space or time (.e. audiences wearing a device like the HoloLens). The system and method herein, in various embodiments, may allow for the solution to rendering problems associated with creating three-dimensional models with DSLR cameras, may allow for simplification of moving subjects into digital realms, provide an uncanny valley workaround for video games and simulations by recording live actors in a full panorama before inserting the video into virtual/augmented/mixed reality applications, and provide higher quality but less expensive special effects. The “uncanny valley” phenomenon is a known issue with three-dimensional renderings where content that is realistic but not realistic enough results in a disconnect in viewers that may seem creepy or off-putting. Various embodiments of the system and method herein may allow for reduction in cost and increase in quality of known styles of special effects (see, e.g., The Matrix, Orphan Black, Tupac Hologram) while also increasing their spatial range of movement. This may allow for special affects availability to less affluent studios, access to virtual reality in theater, and to amateur actors and dancers.

The system and method herein may also, in various embodiments, allow new ways of experiencing media. A non-limiting example of possible applications using various embodiments of the invention are as follows: hologram dance lessons, martial arts lessons, and physical therapy; hologram/live action theater hybrids, novel storytelling methods; guided virtual reality tours recorded by live actors, historical figures, or testifying witnesses; haunted houses; and pornography. This may allow for virtual reality in a theater as well as augmented reality.

An application of particular utility of various embodiments of the system and method herein may include criminal justice. For example: witnesses, interrogators, and law enforcement could wear virtual reality headsets allowing them to see an immersive three-dimensional virtual crime scene as it was recorded by devices such as the Lieca Geosystems scan station while the system and method herein including a truss assembly 103 records them traveling on an empty stage, in various embodiments. The subjects in this non-limiting example may be holoported back into the virtual crime scene to “walk through” witnesses, investigators, and jurors. In addition, as a non-limiting example, jurors and investigators could be recorded using the system and method herein and inserted into the virtual crime scene in order to clarify facts or aspects of the case requiring a deeper understanding. In various embodiments, instead of rendering three-dimensional digital models from scratch, reenactors could be recorded going through different scenarios on an empty stage and then holoported into the virtual crime scene for later viewing. As another non-limiting example, in various embodiments, law enforcement videos could be constructed using live actors recorded on an empty stage and inserted into a virtual space that is viewed by the trainee. Trainees could even use live ammunition since adversaries are not real. This approach using the system and method herein may also be effective for military training.

The disclosed system and method may allow for an enhanced polygraph evaluation. For example, a subject connected to polygraph gear may be placed inside the system 101, 201 (for example, inside the truss 103). The resultant hologram may then be recorded and analyzed for truthfulness by body and eye motion experts. The subject's interaction with virtual spaces may likewise be recorded and analyzed. For example, if a suspect is placed inside a virtual crime scene while inside the system disclosed herein (for example system 101 or truss 103), where the subject looks, the subject's reaction to crime scene objects such as blood, the way the subject tells their story and how this information relates to the standard polygraph or lie detector technology could be analyzed and truthfulness could be measured and quantified. In other words, the system and method herein may broadly allow for studying a subject as they interact with virtual spaces and virtual content

In various embodiments, the system and method herein may also allow for a medical device that captures a person's full epidermis, for example using the system 101 and truss 103. By allowing for imaging across substantially all angles, a capturing of a substantially complete image of the epidermis may be possible using the system and method herein. In various embodiments, the system and method herein may also include a medical device that captures a person's movements for the measurement and quantification of movement problems. For example, certain disorders may cause gait problems and changes in posture. These conditions could be identified from the subject's gait and movements recorded through use of the system and method herein. Multiple captures using the system and method herein of subjects over time could help track the progression of ALS, Parkinson's or other complex diseases for which no blood tests or metrics currently exist.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g., by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

What is claimed is:

1. A system for capturing three-dimensional images, the system comprising:
a truss assembly having a truss frame defining an interior, the truss assembly coupled to an array of cameras, lights, and microphones directed towards the interior, wherein the truss assembly may be of a polyhedron shape and wherein a subject may be located within the interior;
the array of cameras being distributed throughout the truss assembly.

2. The system of claim 1, wherein the cameras, lights, and microphones capture the subject from enough angles to generate a three-dimensional virtual model of the subject.

3. The system of claim 1, wherein the cameras are faced inward to create inverse panoramas.

4. The system of claim 1, wherein the polyhedron shape is selected from the group including: spherical polyhedron, octagonal bifrustum, tetrakaidecahedron, truncated dodecahedron.

5. The system of claim 1, wherein the truss assembly is suspended by way of a suspension truss.

6. The system of claim 5, wherein the truss assembly is suspended over a moving walkway.

7. The system of claim 2, wherein the subject is moving and the truss assembly moves with the subject.

8. Holograms captured using the system of claim 1 that can move through space when played back in alternative reality and virtual reality.

9. method for obtaining an enhanced polygraph test using the system of claim 1.

10. A method for studying subjects as they interact with virtual spaces and virtual content using the system of claim 1.

11. A medical device capturing a subject's movements for the measurement and diagnosis of a medical problem using the system of claim 1.

12. A system for capturing three-dimensional images, the system comprising:
a truss assembly having a truss frame, the truss assembly coupled to an array of microscopes, wherein the truss assembly may be of a polyhedron shape defining an open area where a subject may be located.

13. The system of claim 12, wherein the microscopes are digital microscopes each having a microscope camera.

14. The system of claim 13, wherein the digital microscopes may be moved towards and away from the subject.

15. Holograms captured using the system of claim 12 that can move through space when played back in alternative reality and virtual reality.

16. A system for capturing three-dimensional images, the system comprising:
a plurality of drones aligned in a polyhedron shape defining an open area where a subject may be located, each drone of the plurality of drones having a camera.

17. The system of claim 16, wherein the plurality of drones are configured to capture the subject from enough angles to generate a three-dimensional virtual model of every frame.

18. The system of claim 16, further comprising a method for storing, transporting, and charging the plurality of drones.

19. Holograms captured using the system of claim 16 that can move through space when played back in alternative reality and virtual reality.

20. A method for identifying, cataloging, and tracking individual plants in a crop using the system of claim 16.
